(19) United States
(12) Patent Application Publication
(10) Pub. No.: US 2005/0278177 A1
(43) Pub. Date: Dec. 15, 2005

(54) Techniques for interaction with sound-enabled system or service

(76) Inventor: Oded Gottesman, Goleta, CA (US)

Correspondence Address: ODED GOTTESMAN, 7555 SEA GULL DRIVE, GOLETA, CA, 93117, US

(21) Appl. No.: 10/386,174

(22) Filed: Mar. 11, 2003

(51) Int. Cl. G10L 21/00

(52) U.S. Cl. 704/270

(57) ABSTRACT

Automated interaction systems and methods for use with and/or respond to automated sound-enabled systems, commonly called Interactive Voice Response (IVR) systems. The invented method involves with some or all of the followings; (a) recording information, (b) analyzing signals, (c) initiating and/or participating in communication call, (d) detecting the presence of human individual (instead of IVR system) in the call, (e) signal the caller about such human individual presence, and/or (f) signaling in order to initiate communication and/or call transfer to another destination. This technique can reduce the time spent on, cost involved with, distraction caused by, and need to being put on hold, and/or the need to manually operate or respond to the common IVR systems. The invention can completely or partially release the caller, or assist her/him, during such a process. In costly connections such as wireless, cellular, long distance, or international calls, the method and system can be utilized by a system that is located such that its connection is cheaper than the caller's connection, the system notifies or responds to the caller only when needed, and hence reduces the caller's charges, and improves its reachability and availability via communication devices and/or networks.

### BACKGROUND OF THE INVENTION

1. Field of the Invention

This invention relates generally to data communications and to communication services, more specifically it provides method and system to activate, operate, and/or interact with Interactive Voice Response (IVR) systems, which are typically operated and used via communication systems or networks, and which commonly require caller to input or to provide information and/or answer to questions or menu selection, and/or put the caller on hold. Such invented systems may be used to save the caller time, assist caller in data input, release the called from interacting with such IVR systems, save communications charges, and/or improve caller reachability.

2. Description of Prior Art

In an effort to reduce labor costs, many companies utilize and many service providers provide automated IVR services such as directory assistance, automated direction of calls, input of code or other numbers such as identification or account numbers, or keep callers on hold while being transferred or until human operator or assistant becomes available. Systems that provide such services are commonly called Interactive Voice Response (IVR) systems. For simplicity we will herein use the abbreviation IVR to denote all systems that provides some or all of the above services.

Means of communications develop and become more commonly used throughout our daily life. As a result, people encounter more often automated sound-enabled services, and as a result, spend more time on interacting with them. But, while a lot has been done to improve and to prevail the usage of such services by increasing their friendliness, simplicity, features, and benefits to the provider, very little, if anything at all, has been done to help callers in shortening the time of their interaction with such services. Callers spend an already substantial and further increasing amount of time on interacting with such services which in many cases require input of numbers and/or command via voice or tones, and/or waiting while being transferred or being put on hold for live operator or representative. In many cases such as in long distance, international, or cellular call, the cost of the line and communication infrastructure used, which is paid by the caller or the service provider, is very expensive.

The purpose of the present invention is to save time, costs, and distraction to the caller that has to interact with the dramatically increasing number of automated sound-enabled services.

For the purpose of the present disclosure, the Interactive Voice Response (IVR) may be deem synonymous with sound-enabled services or systems accessed over the phone, Internet, wireless or other communications or networked device, such as “automated directory assistance”, “self-service banking”, “electronic-mail reading”, “unified messaging services”, and “voice mail retrieving”.

For the purpose of the present disclosure, the “interactor” may be deem synonymous with a system that replaces the human caller and interacts with IVR system. The interactor can use prior information provided by the caller, and also fulfill other functions desired by the caller, based on the caller pre-setup and the result of the interactor's interaction with the sound-enabled service. The interactor can also interact with human operator to transmit or receive information, on behalf of the caller.

### SUMMARY OF THE INVENTION

System and method used to save time, costs, and distraction to a caller that needs to interact with IVR system such as directory assistance system, automated or live operator, or unified messaging system. In one embodiment described a local interactor system, and in a second embodiment described a remote interactor system. Each interactor system interacts with IVR system. The interactor system can perform some or all the followings: (a) be programmed to characterized operation, (b) receive, store and/or retrieve information, (c) analyze and/or synthesize signals, (d) interact with IVR system to save the caller intervention, time, costs, and distraction. When interacting with IVR system or with human operator, the interactor system generates signals that are (a) responsive to requests or requested information, and/or (b) based upon identifying information needed for the IVR system, and/or (c) corresponding to information stored in the interactor memory. For example, in case where the interactor system interacts with IVR system, information can be requested on behalf of the caller via the interactor, utilizing the present invention. Such information to be retrieved from a database by IVR system or operator, can include such examples as telephone numbers, internet domain names, internet electronic mail addresses, electronic messages, or financial information.

The interactor system, utilizing the present invention, can be embedded in or be part of an existing device such as telephone, wireless phone, voice-over-Internet protocol (VoIP) phone or other communication device or software, computer, laptop or pocket personal computer (PC), personal digital assistant (PDA), and/or teleconferencing system. It can also share some of the device's resources or components, such as speaker, microphone, handset, tone detector, tone generator, speech recognizer, speech synthesizer, channel interface, user interface, memory, and/or signaling system.

One object of the invention is to introduce automation that reduces caller interaction with sound-enabled service and system while making the introduction of this technology transparent to the sound-enabled service while reducing caller's time, costs and caller's communications time.

Another object of the present invention is to increase the efficiency and the number of correct interactions given out by the sound-enabled service and system.

Still another object of the present invention is to improve the caller's reachability and availability via communications devices and/or networks, for example in case the caller which is put on hold becomes available to communicate via another line, or she/he even becomes free to leave the location where he is presently connected by having the interactor forwards the call or its outcome to the caller at another destination upon desired call result is achieved by the interactor.

Another object of the present invention is to reduce costs by reducing the amount of time spent on interaction with sound-enabled service via expensive lines such as long distance or wireless communications, and connecting the caller only if and when needed.

### BRIEF DESCRIPTION OF THE DRAWING

FIG. 1 is a hardware block diagram setting forth a local interactor system with IVR system in accordance with the first embodiment disclosed herein;

FIG. 2 is a hardware block diagram setting forth a remote interactor with IVR system in accordance with the second embodiment disclosed herein;

### DETAILED DESCRIPTION OF THE PRESENT EMBODIMENT

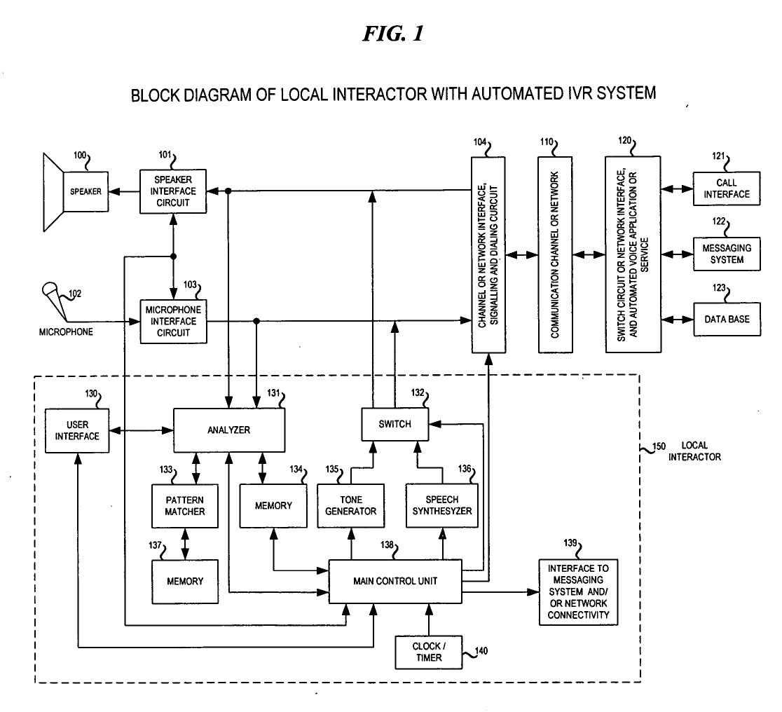

Refer to FIG. 1, which is a hardware block diagram setting forth a local interactor 150 with IVR system 120 in accordance with the first embodiment to be described below. A speaker 100 driven by speaker interface circuit 101 is used to produce sound that is responsive to signal that is received as part of a call via 104, and/or is emanated from the interactor's tone generator 135 or speech generator 136 as part of the interactor operation. A microphone 102 driven by speaker interface circuit 103 is used to capture sound and generate responsive signal to be transmitted as part of a call, and/or to be input to the interactor's analyzer 131 as part of the interactor operation. The user interface 130 is used to transmit information between the user and the interactor, such as commands, text, handwriting, other device or stored data that conveys the user's information. The local device interfaces with the channel or network 110 via the channel or network interface 104. The IVR system 120 is connected at the other end of the channel or network 110. The IVR system 120 can be connected for example to human operator via call interface 121, and/or messaging system 122, and/or data base 123 to retrieve or store information. The received signal is input to the local interactor's analyzer 131, which analyzes it using pattern matcher 137 that detects tones, and/or recognizes speech utterances. The pattern matcher uses reference tones and/or speech characteristics in memory 137. The analyzer uses an additional memory 134, and is controlled by the main control unit 138 to which it outputs the outcome of analysis such as tone detection or speech recognition. The main control unit 138 controls all the interactor's components. It can activate tone generator 135, and/or speech synthesizer 136, to output desired signal to the line via a switch 132. The user can program the interactor by a sequence of commands entered through the user interface 130, and/or using voice utterances captured by the microphone 102 and its interface 103 which are analyzed and recorded by the analyzer 131 using the memory 134. During this process, the user can monitor the recorded information via the user interface, and/or by signal emanated from the speech generator 135 passes through switch 132 and played through the speaker 100 via the speaker interface circuit 101. The main control unit 138 controls the channel or network interface 104. The main control unit 138 can control the speaker and the microphone interface, for example to signal the caller, to connect or to disconnect him. The main control unit 138 can interface through 139 with other communication system or network, such as messaging system, in order to forward the call to the caller and/or to her/his desired destination, or messaging the caller about the outcome of the call. Some of the operations such as tone generation, or speech synthesis, can be involved with timing, which is determined using the clock and/or timer 140.

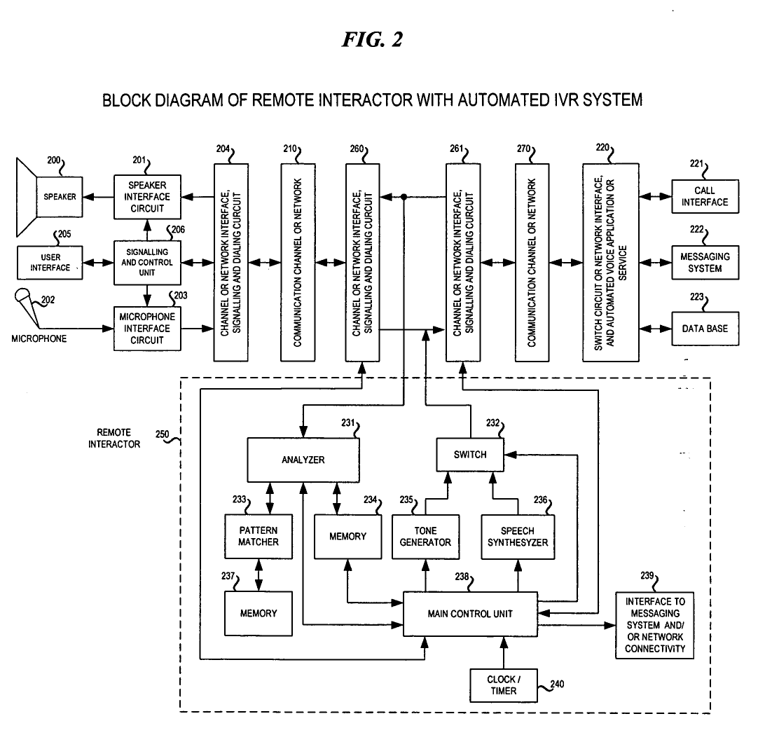

FIG. 2 is a hardware block diagram setting forth a local communication system or device, consists of 200-206, remote IVR system 220, and remote interactor 250 that communicates and serves the local caller and interacts with the remote IVR system 220, in accordance with the second embodiment to be described below. The caller interfaces through the channel 210, using the channel or network interface and signaling and/or dialing interface 204, where the channel or network 210 can also include switch circuits and/or hubs. Similarly remote IVR system 220 interfaces through the channel or network 270, using channel or network interface and signaling and/or dialing interface, where the channel or network 270 can also include switch circuits and/or hubs. The remote interactor can communicates with both or either the local caller and/or remote IVR system 220 system using channel or network interface and signaling and/or dialing interfaces 260 and 261. A speaker 200 driven by speaker interface circuit 201 is used to produce sound that is responsive to signal that is received as part of a call via 204, and/or is emanated from the interactor's tone generator 235 or speech generator 236 as part of the interactor operation. A microphone 202 driven by speaker interface circuit 203 is used to capture sound and generate responsive signal to be transmitted as part of a call, and/or to be input to the interactor's analyzer 231 as part of the interactor operation. The user interface 230 is used to transmit information between the user and the interactor, such as commands, text, handwriting, other device or stored data that conveys the user's information. The local device interfaces with the channel or network 210 via the channel or network interface 204. The IVR system 220 is connected at the other end of the channel or network 210. The IVR system 220 can be connected for example to human operator via call interface 221, and/or messaging system 222, and/or data base 223 to retrieve or store information. The received signal is input to the local interactor's analyzer 231, which analyzes it using pattern matcher 237 that detects tones, and/or recognizes speech utterances. The pattern matcher uses reference tones and/or speech characteristics in memory 237. The analyzer uses an additional memory 234, and is controlled by the main control unit 238 to which it outputs the outcome of analysis such as tone detection or speech recognition. The main control unit 238 controls all the interactor's components. It can activate tone generator 235, and/or speech synthesizer 236, to output desired signal to the line via a switch 232. The user can program the interactor by a sequence of commands entered through the user interface 230, and/or using voice utterances captured by the microphone 202 and its interface 203 which are analyzed and recorded by the analyzer 231 using the memory 234. During this process, the user can monitor the recorded information via the user interface, and/or by signal emanated from the speech generator 235 passes through switch 232 and played through the speaker 200 via the speaker interface circuit 201. The main control unit 238 controls the channel or network interface 204. The main control unit 238 can control the speaker and the microphone interface, for example to signal the caller, to connect or to disconnect him. The main control unit 238 can interface through 239 with other communication system or network, such as messaging system, in order to forward the call to the caller and/or to her/his desired destination, or messaging the caller about the outcome of the call. Some of the operations such as tone generation, or speech synthesis, can be involved with timing, which is determined using the clock and/or timer 240.

The proposed interactor system can have various modes of operation such as; (a) pre-setting or pre-programming mode, (b) real-time setting-record mode, (c) preset command execution, (d) semi-automatic interaction (e) fully automatic interaction, (f) human operator presence detection, (g) caller signaling, messaging, or call forwarding. Below is a detailed description of the modes:
(a) Pre-setting or pre-programming mode: the user input sequence of commands, numbers, information, and/or utterances to the interactor, and the respective characteristics are stored in the memory 134. Some of the information provided to the interactor system during this phase can include user's specific information, characteristic or descriptive information of the caller's desired interaction with and/or request posted to the IVR service or system.
(b) Real-time setting-record mode: the user interacts with the IVR system, while the interactor analyzes and records the characteristics of the ongoing interaction of the caller and the IVR service or system. The respective characteristics are stored in the memory 134.
(c) Preset command execution: the interactor interacts with the IVR system based on the characteristics are stored in the memory 134,
(d) Semi-automated analysis and interaction: the interactor operates semi-automatically, and bases its interaction on a priori information specific to the IVR system such as its service menu selection structure.
(e) Fully-automated analysis and interaction: the interactor operates fully automatically without a priori information about the specific IVR system, and bases its interaction for example on signal detection, automatic speech recognition and predetermined associated actions, based on which it can determine what action or selection to perform. Such action can be for example in the form of speech synthesis, text to speech, speech to text, tone generation, access to data bases, signal the caller, or signal the IVR system.
(f) Human operator detection: mostly used when that caller was put on hold, and is waiting for a human operator to be on the line. The interactor detects the presence of human operator on the line. In this mode the interactor can for example play speech utterance to the human in to post a request to verify its presence.
(g) Caller signaling, messaging, or call forward: in this mode the interactor can perform for example one or more of the following; (i) signal the caller based on the outcome of the interaction with the IVR system which can include signaling to the caller that the interaction was completed successfully or unsuccessfully, or that human operator is present and the caller intervention is needed, (ii) transmit message to the caller via some communication line or network, or (iii) forward the call to another destination, or signal to connect a caller at a remote destination.

It should, of course, be noted that while the present invention has been described in terms of an illustrative embodiment, other arrangements will be apparent to those of ordinary skills in the art. For example;

1. While in the disclosed embodiment the interactor is shown in the FIGS. 1 and 2 as a separate scheme, in other arrangements they can be incorporated into another device or apparatus including but not limited to telephone, speaker phone, teleconferencing station, cellular phone, voice over the Internet (VoIP) phone, cellular phone, personal digital assistant (PDA), laptop or pocket personal computer (PC), and wireless communication device.

2. While in the disclosed embodiment, described speaker 100 and 200 and microphone 102 and 202, in other arrangements they can be part of handset or handset-free communications device.

3. While in the disclosed embodiment one speaker 100 and 200 and one microphone 102 and 202 are shown, in other arrangements there could be no or multiple speakers and/or microphones.

4. While in the disclosed embodiment, speech synthesis and tone generation are utilized, in other applications only one of them can be used.

5. While in the disclosed embodiment, speech synthesis 136 and 236 and tone generation 135 and 235 are utilized, in other applications each or any of this function can be performed by another device or system that interfaces directly or indirectly with the disclosed embodiment system.

6. While in the disclosed embodiment, user interface 130 and 230 is utilized, in other applications user input can be received by another device or system that interfaces directly or indirectly with the disclosed embodiment system.

7. While in the disclosed embodiment, tone generator 135 and 235 and/or speech synthesizer 132 and 232 are utilized, in other applications generated tone and/or speech can be received from another device or system that interfaces directly or indirectly with the disclosed embodiment system.

8. While in the disclosed embodiment, speech synthesizer 132 and 232 is utilized, in other applications text-to-speech can be used with the disclosed embodiment system.

9. While in the disclosed embodiment, speech analyzer 131 and 231 is utilized, in other applications speech-to-text can be used with the disclosed embodiment system.

10. While in the disclosed embodiment, analyzer 131 and 231 is utilized, in other applications tone detection and/or speech recognition outcome can be received from another device or system that interfaces directly or indirectly with the disclosed embodiment system.

11. While in the disclosed embodiment the IVR system. 120 and 220 is connected to call interface 121 and 221, messaging system 122 and 222, and data base 123 and 223, other arrangements will be apparent to those of ordinary skills in the art. For example, only some of the systems or other systems or services can be connected to or used by the IVR system 120 and 220, and/or such a connection can require additional switch, controller, driver, or other form of interface.

12. While in the disclosed embodiment the main control unit 138 and 238 is connected to messaging system and/or network connectivity 139 and 239, in other arrangements can be no connection to interface, or connection to multiple interfaces, or other form of connectivity to another system, device, or network.

13. While in the disclosed embodiment one channel or network 110, 210, and 270 is shown, other arrangements will be apparent to those of ordinary skills in the art. For example, the combination of networks, tandeming, switches, routers, gateways, hubs, and bridges, and/or transmission stations, can be used.

14. While in the disclosed embodiment in two communication lines are shown, other arrangements will be apparent to those of ordinary skills in the art. For example, one line connection, network of lines, and or combination of networks, tandeming, switches, routers, gateways, hubs, and bridges, and/or transmission stations, can be used.

15. While in the disclosed embodiment speech synthesizer 136 and 236, is shown, in other arrangements no speech synthesizer is used.

16. While in the disclosed embodiment two memories 134/234 and 137/237 are described, other arrangements will be apparent to those of ordinary skills in the art. For example, one memory device can be used for both memories, the system can share memory with another device or system, and/or more memories can be used.

17. While in the disclosed embodiment a clock or timer 140 and 240, is shown, in other arrangements no clock or timer device is used, and/or timing can be extracted from another source, such as the network.

18. Finally, while the disclosed embodiment utilized discrete devices, these devices can be implemented using one or more appropriately programmed general-purpose processors, or special-purpose integrated circuits, or digital processors, or an analog or hybrid counterpart of any of these devices.

1. A method for interfacing and/or interaction and/or communication with sound-enabled system or service, such as Interactive Voice Response (IVR) system or service, by receiving and/or transmitting signals or data over communication channel or network, the method comprising the steps of:
(a) partitioning the communication into different time instances and/or different data exchange units; and
(b) receiving and analyzing data received from the IVR system, where the data exchange may be in the form of sounds or signals; and
(c) computing data that is corresponding to and/or in response to the data received from the IVR system; and
(d) generating and/or transmitting to the IVR system data corresponding to the data computed in (c), where the data exchange may be in the form of sounds or signals.

2. A method for interfacing and/or interaction and/or communication with sound-enabled system or service, such as Interactive Voice Response (IVR) system or service, by receiving and/or transmitting signals or data over communication channel or network, the method comprising the steps of:
(a) having pre-stored data corresponding to a desired operation of the IVR system and/or user characteristic data; and
(b) partitioning the communication into different time instances and/or different data exchange units; and
(c) generating and/or transmitting to the IVR system data corresponding to pre-stored data in (a), where the data exchange may be in the form of sounds or signals.

3. The method of claim 2 further comprising of the steps of:
(a) receiving and analyzing data received from the IVR system, where the data exchange may be in the form of sounds or signals; and
(b) computing data that is corresponding to or in response to the data received from the IVR system and/or to pre-stored data in step (a) of claim 2; and
(c) generating and/or transmitting to the IVR system data corresponding the computed data in (b), where the data exchange may be in the form of sounds or signals.

4. A method for detecting the presence of human operator or caller when and/or after interfacing and/or interaction and/or communication with sound-enabled system or service, such as Interactive Voice Response (IVR) system or service, by receiving and/or transmitting signals or data over communication channel or network, the method comprising the steps of:
(a) while communicating with the IVR, partitioning the communication into different time instances and/or different data exchange units; and
(b) receiving and analyzing data received from the IVR system or from human operator, where the data exchange may be in the form of sounds or signals; and
(c) selecting whether human operator or IVR system is present on the communication channel.

5. A method for detecting the presence of human operator or caller when and/or after interfacing and/or interaction and/or communication with sound-enabled system or service, such as Interactive Voice Response (IVR) system or service, by receiving and/or transmitting signals or data over communication channel or network, the method comprising the steps of:
(a) while communicating with the IVR, partitioning the communication into different time instances and/or different data exchange units; and
(b) generating and/or transmitting to the IVR system and/or to human operator data corresponding to pre-stored data in (a), where the data exchange may be in the form of sounds or signals; and
(c) receiving and analyzing data received from the IVR system or from human operator, where the data exchange may be in the form of sounds or signals; and
(d) selecting whether human operator or IVR system is present on the communication channel.

6. A method for signaling or acting a result of detecting the presence of human operator or caller when and/or after interfacing and/or interaction and/or communication, on behalf of a user, with sound-enabled system or service, such as Interactive Voice Response (IVR) system or service, by receiving and/or transmitting signals or data over communication channel or network, the method comprising the steps of:
(a) having pre-stored data corresponding to a desired operation needed in response to detection of presence of human operator or caller connected to the communications channel or network; and
(b) while communicating with the IVR, partitioning the communication into different time instances and/or different data exchange units; and
(c) receiving and analyzing data received from the IVR system or from human operator, where the data exchange may be in the form of sounds or signals; and
(d) selecting whether human operator or IVR system is present on the communication channel; and
(e) performing a desired operation, such as signaling to the user and/or signaling to the network control system to transfer the ongoing call to a desired destination, based on the pre-stored data in (a).

7. A method for signaling or acting a result of detecting the presence of human operator or caller when and/or after interfacing and/or interaction and/or communication, on behalf of a user, with sound-enabled system or service, such as Interactive Voice Response (IVR) system or service, by receiving and/or transmitting signals or data over communication channel or network, the method comprising the steps of:
(a) having pre-stored data corresponding to a desired operation needed in response to detection of presence of human operator or caller connected to the communications channel or network; and
(b) while communicating with the IVR, partitioning the communication into different time instances and/or different data exchange units; and
(c) generating and/or transmitting to the IVR system and/or to human operator data corresponding to pre-stored data in (a), where the data exchange may be in the form of sounds or signals; and
(d) receiving and analyzing data received from the IVR system or from human operator, where the data exchange may be in the form of sounds or signals; and
(e) selecting whether human operator or IVR system is present on the communication channel; and
(f) performing a desired operation, responsive to the detection result in (e), such as signaling to the user and/or signaling to the network control system to transfer the ongoing call to a different destination, based on the pre-stored data in (a).

8. A method for recording and storing data corresponding to a desired operation of and interaction with sound-enabled system or service, such as Interactive Voice Response (IVR) system or service and/or user characteristic data, the method comprising the steps of:
(a) receiving and analyzing from the user data to be used for and/or to be used in future communications and/or automated interaction with IVR system; and
(b) generating appropriate data, representative of the data in (a), to be stored for future communications and/or automated interaction with the IVR; and
(c) storing the data in (b) to memory media or device.

9. A method for recording and storing data corresponding to a desired operation of and interaction with sound-enabled system or service, such as Interactive Voice Response (IVR) system or service and/or user characteristic data, the method comprising the steps of:
(a) while a user is communicating with the IVR system, partitioning the communication into different time instances and/or different data exchange units; and
(b) receiving and analyzing data received from the IVR system and/or from user; and
(c) generating appropriate data, representative of the data in (b), to be stored for future communications and/or automated interaction with the IVR; and
(d) storing the data in (c) to memory media or device.

10. A method for signaling and/or initiating communication following interaction with sound-enabled system or service, such as Interactive Voice Response (IVR) system or service, the method comprising the steps of:
(a) receiving data corresponding to a desired operation needed in response to detection of presence of human operator or caller connected to the communications channel or network; and
(b) receiving and analyzing data received from the IVR system or from human operator; and
(c) selecting whether human operator or IVR system is present on the communication channel; and
(d) performing a desired operation, such as signaling to the user and/or signaling to the network control system to initiate call to a desired destination, based on the received data in (a).
